(19) United States
(12) Patent Application Publication
(10) Pub. No.: US 2004/0064540 A1
(43) Pub. Date: Apr. 1, 2004

(54) Supervisory monitoring and controlling system in data transmission system

(76) Inventor: Norio Yanagi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/658,427

(22) Filed: Sep. 10, 2003

(30) Foreign Application Priority Data
Sep. 11, 2002 (JP) 2002-264916

(51) Int. Cl. G06F 15/173

(52) U.S. Cl. 709/223

(57) ABSTRACT

A supervisory monitoring and controlling system in a data transmission system is provided which is capable of having scalability and flexibility by employing WEB computing technology. The supervisory monitoring and controlling system has a WEB browser to display supervisory information and a supervisory monitoring and controlling section to produce supervisory information. The supervisory monitoring and controlling section is made up of a WEB application server and supervisory information management servers. A scale of hardware of the supervisory monitoring and controlling section can be changed flexibly depending on a scale of monitored objects to be supervised and controlled by connecting a Java™ RMI (Remote Method Invocation) interface between the WEB application server and supervisory information management servers.

### BACKGROUND OF THE INVENTION

1. Field of the Invention

The present invention relates to a supervisory monitoring and controlling system in a data transmission system, and more particularly to the supervisory monitoring and controlling system in the data transmission system being suitably used for supervisory monitor and control on a monitored object to be supervised having a two or more layered structure.

The present application claims priority of Japanese Patent Application No. 2002-264916 filed on Sep. 11, 2002, which is hereby incorporated by reference.

2. Description of the Related Art

It is important to supervise an operating state of equipment, devices, circuit modules, or a like making up a data transmission system used to transmit information in a communication field. To achieve this, a supervisory monitoring and controlling system in a data transmission system is used to supervise these equipment, devices, circuit modules, or a like.

In such the data transmission system, communication stations each serving as a communication terminal station or a relay station are placed in a plurality of locations and each of the stations is generally made up of a plurality of racks. In each of the racks is mounted a receiver, a transmitter, a modulating device and a demodulating device. In the case of optical multiple communications, a plurality of circuit modules having a wavelength multiplexing function, a wavelength de-multiplexing function and a like are mounted in each of the rack.

That is, the data transmission system can be considered to be a system having a three-layered structure in which the circuit module is located and monitored in an NEL (Network Element Layer) being a lower layer, the rack is located and monitored in an EML (Element Management Layer) being an intermediate layer, and the station is located and monitored in an NML (Network Management Layer) being a higher layer. The conventional supervisory monitoring and controlling system in the data transmission system considered to be a system having such the layered structure is described by referring to FIG. 11.

As shown in FIG. 11a, station A and a station B are placed in two locations being apart from each other. The station A is made up of racks A₁, A₂, and A₃ and the station B is made up of racks B₁, B₂, and B₃ and each of the racks consists of a plurality of modules (not shown). Supervisory monitoring sections 101 and 102 are placed to supervise the lower layer (NEL) and supervisory monitoring sections 201 and 202 are placed to supervise the intermediate layer (EML). A supervisory monitoring section 300 is placed to supervise the higher layer (NML). In the conventional supervisory monitoring and controlling system shown in FIG. 11, since a supervisory monitoring terminal serving as the supervisory monitoring sections are individually placed for every supervisory layer NEL, EML, and NML, it is difficult to flexibly change configurations of the supervisory monitoring and controlling system depending on a scale of a device and/or system to be supervised.

A remote type of supervisory monitoring and system is disclosed in Japanese Patent Application Laid-open No. 2000-250844 (see pages 3-4, FIG. 1 of the same document) in which, even in the case of supervision on a monitored object to be supervised having a layered structure, by reducing an amount of network transmission for a supervisory state, a load on the network can be reduced. That is, in the supervisory monitoring and controlling system of this type, a supervisory server is placed through a network between the monitored object to be supervised having the layered structure and a supervisory monitoring terminal in which a Java™-enabled WWW browser is installed and the supervisory server is driven by the supervisory monitoring terminal through the network to acquire, from the supervisory server, information about supervision on the monitored object to be supervised and to display the information on a screen.

As described above, the conventional supervisory monitoring and controlling system as shown in FIG. 11 has a disadvantage in that, since the supervisory monitoring terminal is placed in every layer of a monitored object to be supervised having a layered structure, flexible change of configurations of the supervisory monitoring and controlling system depending on a scale of a monitored object to be supervised is difficult. It has another advantage in that, even when each layer is supervised in a unified manner, since each layer has a different architecture, a procedure for a system integration of different architectures is required, which causes a device and/or system to be supervised to be complicated and causes a user interface of the supervisory monitoring and controlling system to become difficult to be understood.

In the supervisory monitoring and controlling system disclosed in Japanese Patent Application Laid-open No. 2000-250844 as described above, even when a monitored object to be supervised is of a layered structure, the supervision and control is performed in a unified manner using the WWW browser and the supervisory server, however, an increase in the monitored objects to be supervised and controlled each having a layered structure requires additional supervisory servers, which causes the supervisory monitoring and controlling system to be lacking in flexibility.

### SUMMARY OF THE INVENTION

In view of the above, it is an object of the present invention to provide a supervisory monitoring and controlling system in a data transmission system which is capable of flexibly changing its configurations depending on a scale of a monitored object to be supervised. It is another object of the present invention to provide the supervisory monitoring and controlling system which is capable of being developed by using an architecture that can develop the supervisory monitoring and controlling system to supervise all layers to be supervised in a unified manner and of supervising and controlling all layers making up networks to circuit modules by using only one client terminal.

According to a first aspect of the present invention, there is provided a supervisory monitoring and controlling system in a data transmission system including:

a WEB browser to display information about supervision on a monitored object to be supervised;

a supervisory monitoring and controlling unit to produce information about supervision and control on the monitored object to be supervised and to feed the information to the WEB browser; and

wherein the supervisory monitoring and controlling unit has at least one WEB application server to produce the information about the supervision and control on the monitored object to be supervised as the information being able to be displayed by the WEB browser, and at least one supervisory information management server to collect and manage the information about the supervision and control on the monitored object to be supervised and to feed it to the WEB application server, and wherein the WEB application server and the supervisory information management server are physically separated.

In the foregoing, a preferable mode is one wherein a Java™ RMI (Remote Method Invocation) interface is connected between the WEB application server and the supervisory information management server.

Also, a preferable mode is one wherein a plurality of the WEB application servers is placed depending on a scale of the monitored object to be supervised.

Also, a preferable mode is one wherein a plurality of the supervisory information management servers is placed depending on a scale of the monitored object to be supervised.

Also, a preferable mode is one wherein the monitored object to be supervised is of a two or more layered structure and the plurality of the supervisory information management servers are so configured as to manage, in a shared manner, the supervisory monitoring and controlling information corresponding to each of layers making up the layered structure.

Also, another preferable mode is one wherein exchange of information between the WEB application server and the WEB browser is carried out by an HTTP (Hyper Text Transfer Protocol).

Also, still another preferable mode is one wherein exchange of information between the supervisory information management server and the monitored object to be supervised is carried out by a TCP/IP (Transmission Control Protocol/Internet Protocol).

Furthermore, a preferable mode is one wherein the WEB browser is a browser for a mobile terminal and the WEB application server is so configured as to produce information being able to be displayed by the browser for the mobile terminal.

With the above configuration, the supervisory monitoring and controlling system in a data transmission system that had been conventionally developed individually to supervise each layer (NEL, EML, and NML) can be developed by an architecture that that can develop a supervisory monitoring and controlling system in a data transmission system to supervise all layers to be supervised in a unified manner, and supervision and control on all monitoring objects of a network to circuit modules by using only one client terminal (WEB browser) is made possible.

With another configuration, since types and/or numbers of machines (hardware) making up the supervisory monitoring and controlling section are not fixed, the supervisory monitoring and controlling system in a data transmission system that is flexible depending on a scale of monitored objects to be supervised and controlled can be provided. For example, when a scale of a monitored object to be supervised is small, one server machine making up the supervisory monitoring and controlling section is enough.

With still another configuration, the supervisory monitoring and controlling system in a data transmission system of the present invention can be easily connected to other supervisory monitoring and controlling system by introducing a converting adapter enabling operations of the conventional or other supervisory monitoring and controlling system. That is, there is no need for changing any server or client terminal of an existing supervisory monitoring and controlling system since the interface and the WEB server to operate newly added systems for supervisory monitor and control by using the converting adapter are provided.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a supervisory monitoring and controlling system in a data transmission system according to a first embodiment of the present invention;

FIG. 2 is a schematic block diagram showing configurations of a modified supervisory monitoring and controlling system according to the first embodiment of the present invention;

FIG. 3 is a schematic block diagram showing configurations of another modified supervisory monitoring and controlling system according to the first embodiment of the present invention;

FIG. 4 is a schematic block diagram showing configurations of still another modified supervisory monitoring and controlling system according to the first embodiment of the present invention;

FIG. 5 is a schematic block diagram showing configurations of a still further modified supervisory monitoring and controlling system according to the first embodiment of the present invention;

FIG. 6 is a diagram explaining operation sequences of the supervisory monitoring and controlling system according to the first embodiment of the present invention;

FIGS. 7A, 7B, and 7C are diagrams illustrating examples of displayed information obtained by the supervisory monitoring and controlling system shown in FIG. 1 using a WEB browser according to the first embodiment of the present invention;

FIG. 8 is a schematic block diagram showing configurations of a supervisory monitoring and controlling system in a data transmission system according to a second embodiment of the present invention;

FIG. 9 is a schematic block diagram showing configurations of a supervisory monitoring and controlling system in a data transmission system according to a third embodiment of the present invention;

FIG. 10 is a schematic block diagram showing configurations of a supervisory monitoring and controlling system in a data transmission system according to a fourth embodiment of the present invention; and

FIG. 11 is a schematic block diagram showing configurations of a conventional supervisory monitoring and controlling system in a data transmission system.

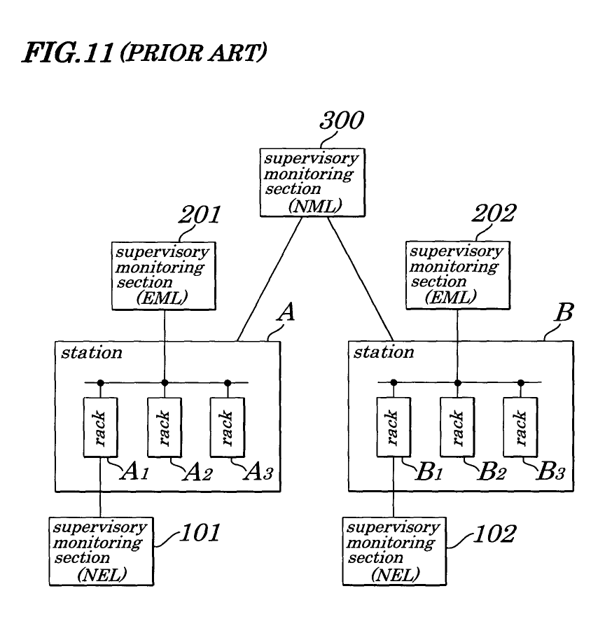

### DETAILED DESCRIPTION OF THE PREFERRED EMBODIMENTS

Best modes of carrying out the present invention will be described in further detail using various embodiments with reference to the accompanying drawings.

### First Embodiment

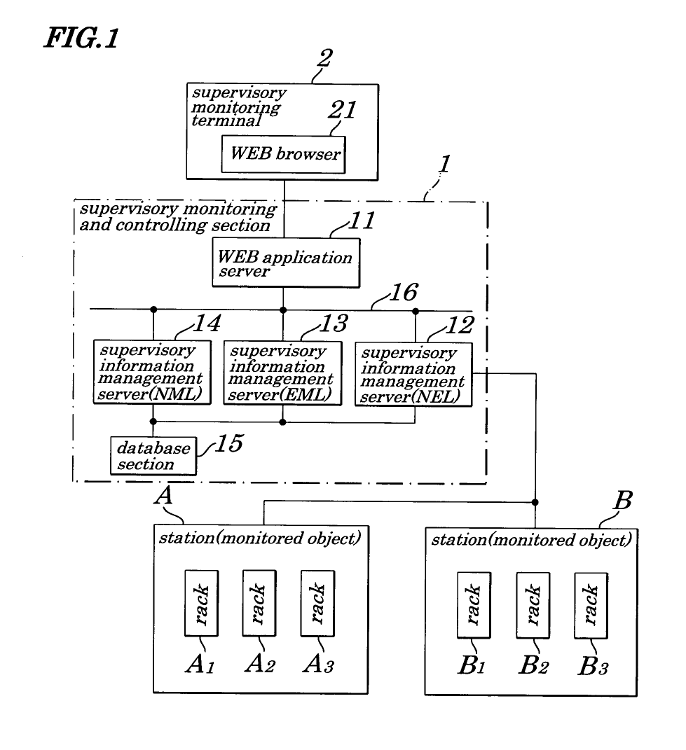

FIG. 1 is a schematic block diagram showing configurations of a supervisory monitoring and controlling system according to a first embodiment of the present invention, which is the system to perform supervision and control on a monitored object to be supervised having a layered structure. As described in the conventional example, a monitored object to be supervised having a layered structure employed in the embodiment is of a three-layered structure made up of, for example, the NEL (Network Element Layer), EML (Element Management Layer), and NML (Network Management Layer). In the embodiment, circuit modules (not shown) are located and supervised in the NEL, racks A₁ to A₃ and B₁ to B₃each being made of the circuit module are located and supervised in the EML, and stations A and B each being made up of the racks are located and supervised in the NML.

The supervisory monitoring and controlling section 1 making up the supervisory monitoring and controlling system of the embodiment includes a WEB application server 11, supervisory information management servers 12 to 14, and a database section 15. The WEB application server 11 has a function of creating a content that can be displayed by using a WEB browser 21 within a supervisory monitoring terminal 2 according to information fed from the supervisory information management servers 12 to 14. By using the WEB browser 21, a GUI (Graphical User Interface) display can be achieved. The WEB application server 11 acquires information from the supervisory information management servers 12 to 14 in response to a demand from the WEB browser 21. In the embodiment, each of the supervisory information management servers 12 to 14 is placed in a manner to correspond to each of the layers (NEL, EML, and NML) in the monitored objects (stations) A and B to be supervised, each having a layered structure. Each of the supervisory information management servers 12 to 14 carries out communications with the stations A and B to be supervised to collect and manage information about each layer making up each of the stations A and B to be supervised and to exchange information with the WEB application server hand the monitored objects (stations) A and B to be supervised. In the embodiment, the supervisory information management server 12 taking charge of the NEL being the lowest layer is connected to the monitored objects (stations) A and B to be supervised. Connection is established so that communications can be carried out among the supervisory information management servers 12 to 14, and between the WEB application server Hand each of the supervisory information management servers 12 to 14 in order to enable physical distribution arrangement of these objects by using a Java™ RMI interface 16.

The database section 15 is used to store information about the stations A and B to be supervised and information about various alarm histories and about configurations (about configurations of the rack, module, or a like) of the stations A and B to be supervised and also backs up data. Communications can be freely carried out between the database 15 and the supervisory information management servers 12 to 14 according to a JDBC (Java™ Data Base Connectivity) interface specification so that contents of the database can be updated. Moreover, data is exchanged between the supervisory information management server 12 and the stations A and B to be supervised according to a TCP/IP (Transmission Control Protocol/Internet Protocol) or a like. Communications are carried out between the WEB application server 11 and the WEB browser 21 in the supervisory monitoring terminal 2 according to an HTTP (Hyper Text Transfer Protocol).

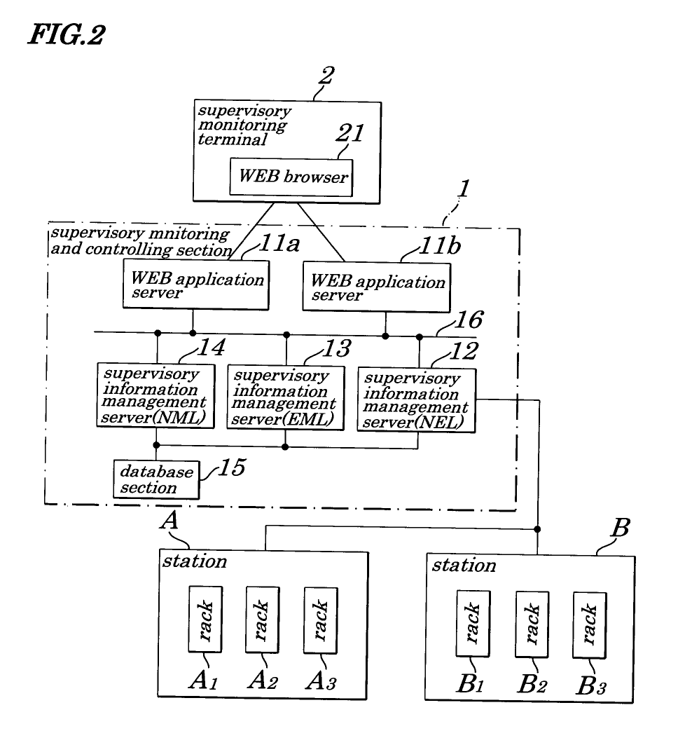

In FIG. 1, only one WEB application server 11 is placed, however, two WEB application servers 11a and 11b (not shown in FIG. 1), or more may be placed depending on a scale of a monitored object to be supervised as shown in FIG. 2.

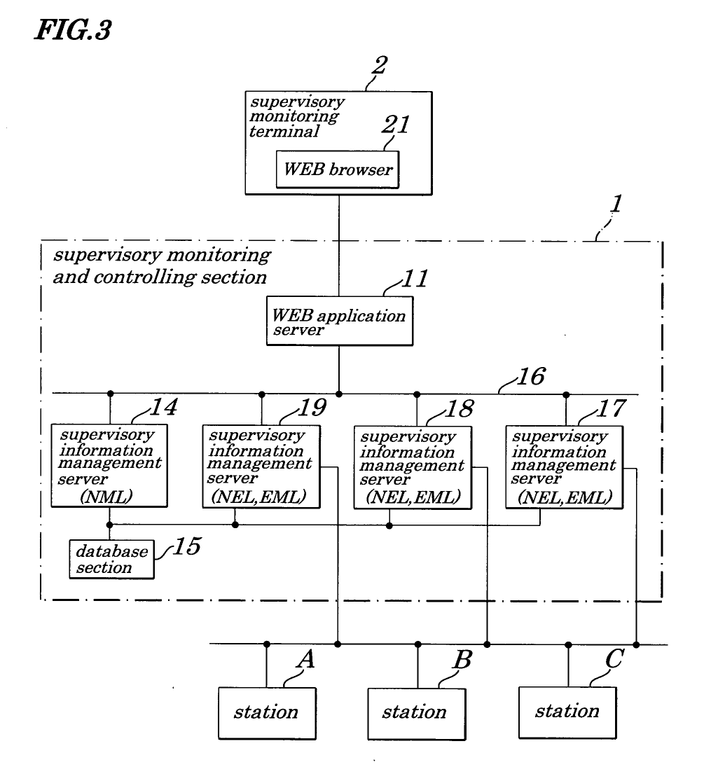

Moreover, as shown in FIG. 3, when a number of the monitored objects to be supervised is increased so that it includes the monitored objects A to a monitored object C, the supervisory monitoring and controlling section 1 may be so configured that the supervisory information management servers are divided into two groups, one group including supervisory information management servers 17 to 19 each supervising two layers of the NEL and EML in each layer contained in the monitored objects A to C to be supervised and another group including the supervisory information management server 14 supervising all the NML in the monitored objects A to C to be supervised.

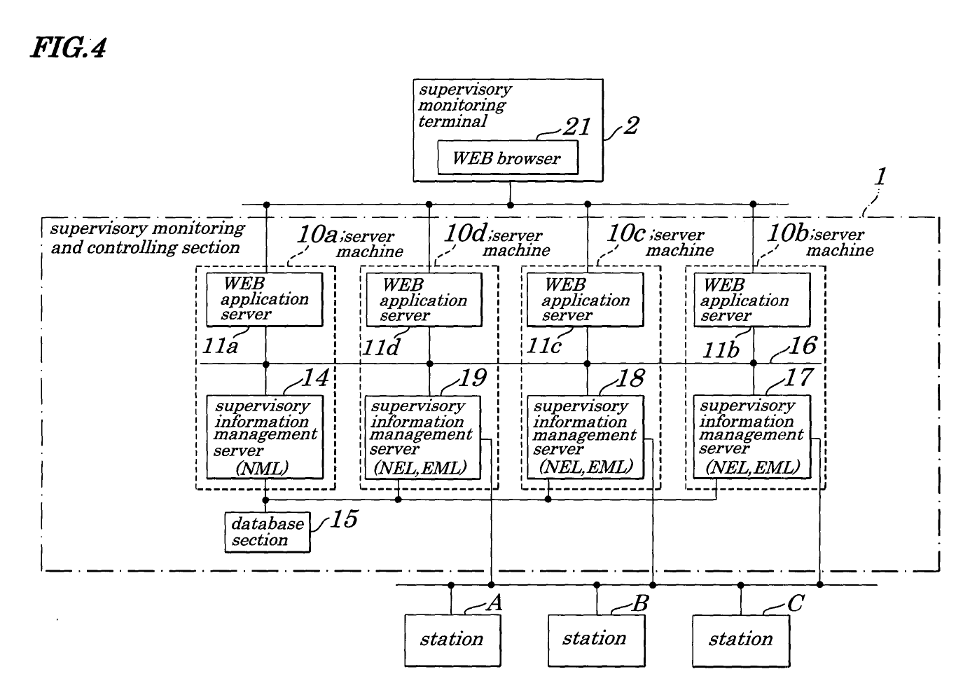

Also, as shown in FIG. 4, the supervisory monitoring and controlling section 1 may be so configured that WEB application servers 11a to 11d each corresponding to each of supervisory information management servers 14 and 17 to 19 are placed and a server machine 10a made up of the supervisory information management server 14 and the WEB application server 11a, a server machine 10d made up of the supervisory information management server 19 and the WEB application server 11a, a server machine 10c made up of the supervisory information management server 18 and the WEB application server 11c, and a server machine 10b made up of the supervisory information management server 17 and the WEB application server 11b are introduced.

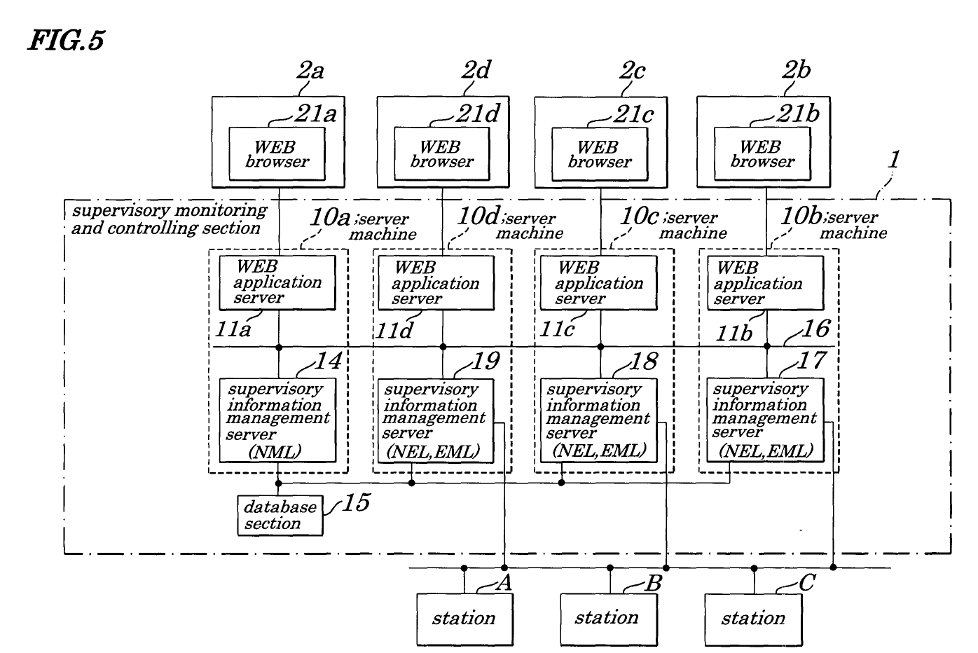

As shown in FIG. 1 to FIG. 4, since a hyperlink is established among the WEB application servers 11a to 11d, each of the WEB application servers 11a to 11d can obtain necessary information from each of the supervisory information management servers 14 and 17 to 19. Thus, if the hyperlink is established among the WEB application servers, when a user logs in to a different WEB application server, processes of taking over an access limitation, of repeatedly logging in to the WEB application server, or a like are necessary. To avoid such the processes, as shown in FIG. 5, the supervisory monitoring and controlling section 1 is so configured that supervisory monitoring terminals 2a to 2d each having each of WEB browsers 21a to 21d and each corresponding to each of the supervisory information management servers 11a to 11d are placed.

In the supervisory monitoring and controlling section 1 as shown in FIG. 5, no hyperlink is established among the WEB application servers 11a to 11d and each of the WEB application servers 11a to 11d obtains necessary information from the supervisory information management servers 14 and 17 to 19. In this case, all that is needed is that each of the WEB browsers 21a to 21d logs in to a corresponding one of the WEB application servers 11a to 11d.

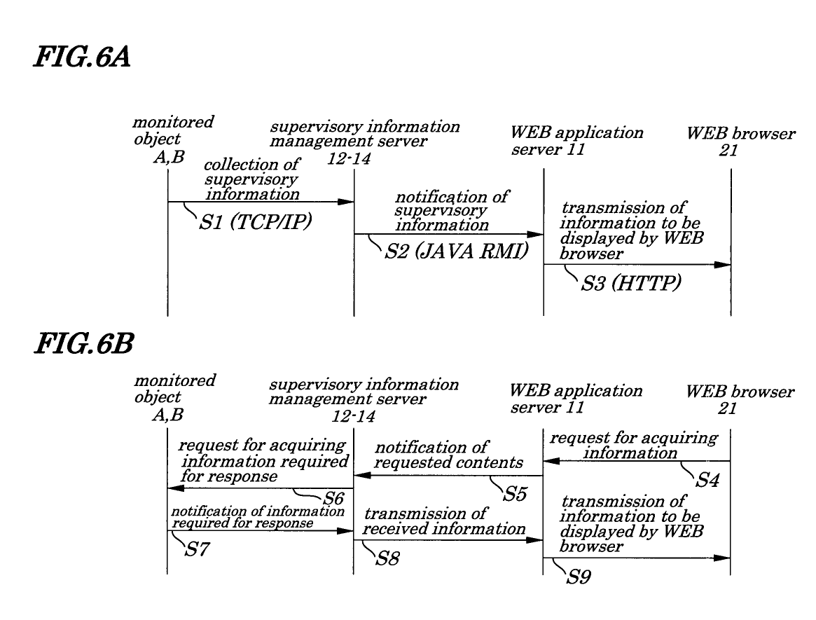

Operations of the supervisory monitoring and controlling system of the embodiment of the present invention are described by referring to the block diagram shown in FIG. 1 and the operation sequence diagram shown in FIG. 6. Let it be assumed in the following description that a failure has occurred in modules (modules “STML11” and “STML21”) of the racks A1 and A2 in the monitored object A to be supervised. When a failure occurs, the supervisory information management server 12 in charge of supervising the NEL is notified, from the monitored object A to be supervised, of information about the time when the failure occurred, a module name, a name of a rack to which the module belongs to, an alarm name, or a like (Step S1 in FIG. 6(a)). The notification is performed using the TCP/IP or a like.

The supervisory information management server 12, in response to the notification, carries out processing on the information about the NEL and sends out information about the EML and the NML to each of the supervisory information management servers 13 and 14. Moreover, the notification information includes information about a flag or a like indicating a layer information about the NEL, EML, or NML and the supervisory information management server 12 identifies the flag information to assign the relevant layer information to each of the supervisory information management servers 13 and 14. The supervisory information management servers 12 to 14, on receipt of the information about each layer, outputs the received information as information that can be processed by the WEB application server 11, by using a Java™ RMI interface 16 (Step S2). The WEB application server 11, in response to supervisory information about each layer, produces information that can be displayed by the WEB browser 21 and transmits it using the HTTP (Step S3).

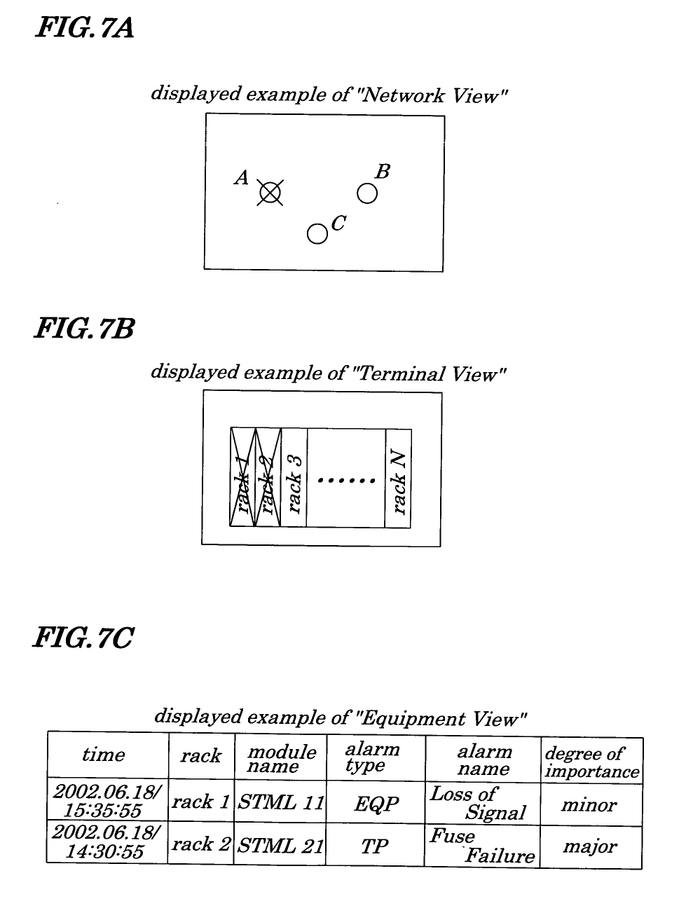

FIGS. 7A, 7B, and 7C are diagrams illustrating a GUI (Graphical User Interface) displayed example of information obtained by the supervisory monitoring and controlling system shown in FIG. 1 using the WEB browser 21 in the supervisory monitoring terminal 2. FIG. 7A is an example of display for “Network View” corresponding to the NML which indicates that a failure has occurred in the monitored object (station) A to be supervised. FIG. 7B is an example of display for “Terminal View” corresponding to the EML which indicates that a failure has occurred in the racks A1 and A2 (Racks 1 and 2 in FIG. 7B). FIG. 7C is an example of display for “Equipment View” corresponding to the NEL which indicates “in which module the failure has occurred”, “what kind of failure has occurred”, “when the failure occurred”, and a like.

To obtain information about a monitored object to be supervised from the WEB browser 21 in the supervisory monitoring terminal 2, processing is carried out according to the operation sequence shown in FIG. 6(b). That is, a request for acquiring information is transmitted from the WEB browser 21 to the WEB application server 11 (Step S4). The WEB application server 11 notifies each of the supervisory information management servers 12 to 14 (Step S5) of contents received and each of the supervisory information management servers 12 to 14 feeds necessary information according to requested contents as a response (Step S8). At this time, information required for a response is acquired from a monitored object to be supervised (Steps S6 and S7) and information is fed as a response according to the acquired contents. The WEB application server 11 according to information fed from the supervisory information management servers 12 to 14, produces information required for the GUI display and sends out the produced information to the WEB browser 21 in the supervisory monitoring terminal 2 (Step S9).

### Second Embodiment

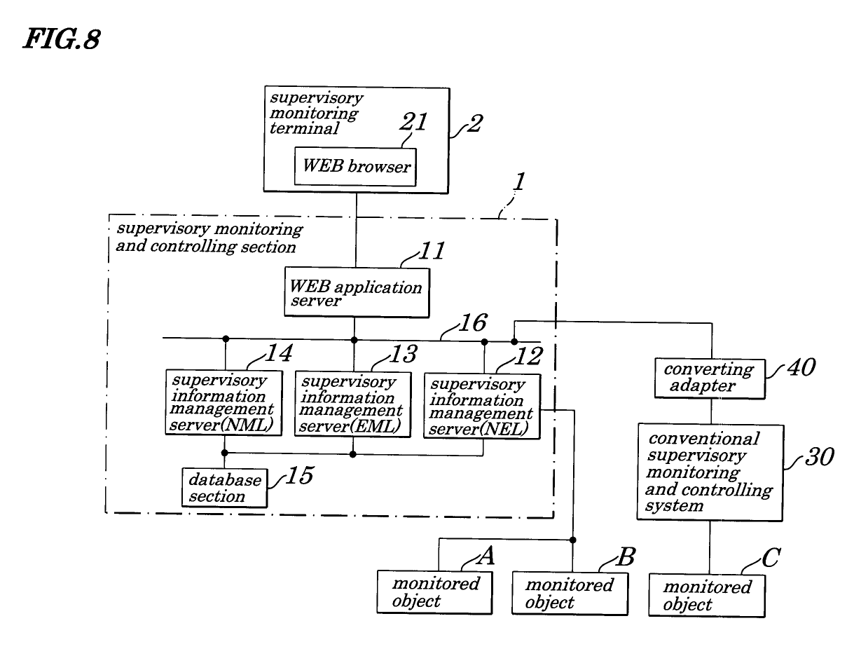

FIG. 8 is a schematic block diagram showing configurations of a supervisory monitoring and controlling system according to a second embodiment of the present invention. Same reference numbers are assigned to components having same functions as those in FIG. 1 and their descriptions are omitted accordingly. Configurations of the supervisory monitoring and controlling system of the second embodiment shown in FIG. 8 differ from those shown in FIG. 1 in that a conventional supervisory monitoring and controlling system 30 and a converting adapter 40 are additionally connected between a Java™ RMI interface 16 and an object C to be supervised. The converting adapter 40 is required when the conventional supervisory monitoring and controlling system 30 supports interfaces other than the Java™ RMI interface 16 and has a function of converting an interface between the Java™ RMI interface 16 and the conventional supervisory monitoring and controlling system 30. By configuring as above, supervision and control on the object C to be supervised can be achieved by using the conventional supervisory monitoring and controlling system 30 through control on a WEB browser 21 in a supervisory monitoring terminal 2.

### Third Embodiment

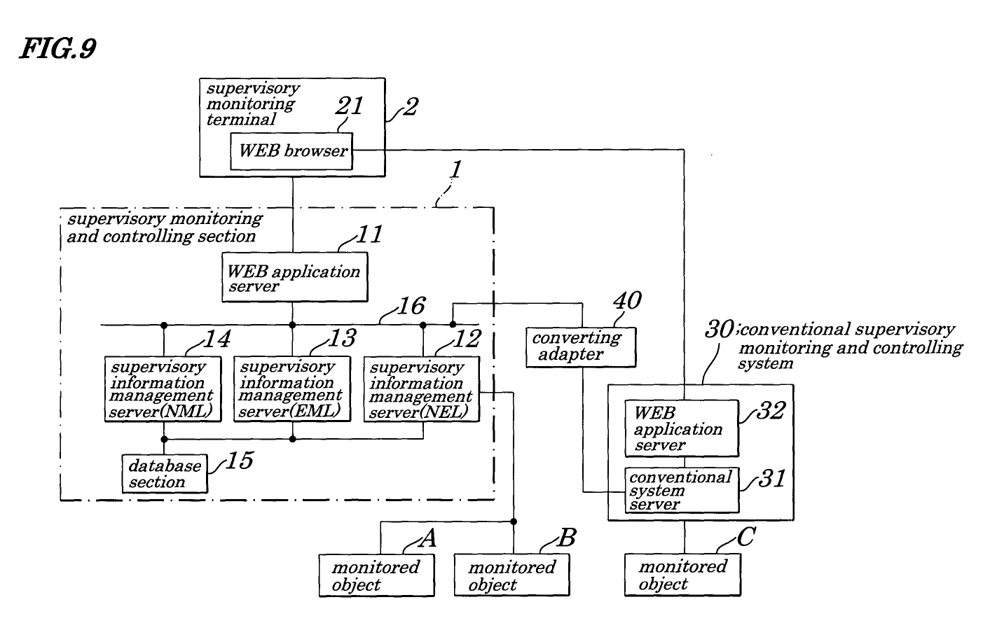

FIG. 9 is a schematic block diagram showing configurations of a supervisory monitoring and controlling system according to a third embodiment of the present invention. Same reference numbers are assigned to components having same functions as those in FIG. 1 and their descriptions are omitted accordingly. In the supervisory monitoring and controlling system of the third embodiment, a conventional supervisory monitoring and controlling system 30 has a WEB application server 32 and a conventional system server 31. By designating an object on which a hyperlink is established by using an HTML in the WEB application server 32, it is made possible to supervise and control not only a monitoring object C obtained from the WEB browser 21 but also other monitoring objects A, B and a like.

### Fourth Embodiment

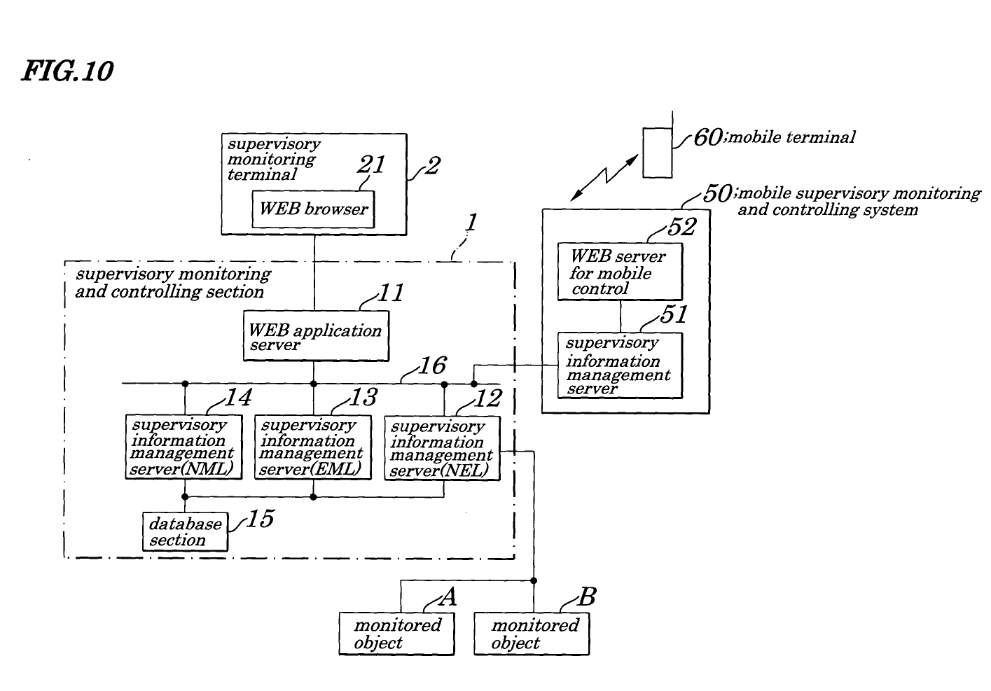

FIG. 10 is a schematic block diagram showing configurations of a supervisory monitoring and controlling system according to a fourth embodiment of the present invention. Same reference numbers are assigned to components having same functions as those in FIG. 1 and their descriptions are omitted accordingly. In the supervisory monitoring and controlling system of the fourth embodiment, a mobile system, a mobile terminal 60, is added to the configurations shown in FIG. 1 which enables supervision and control through the mobile terminal 60. This is realized by a mobile supervisory monitoring and controlling system 50 which includes a supervisory information management server 51 and a WEB server 52 for mobile control. That is, it is possible to display supervisory monitoring information about monitoring objects A and B by using the mobile terminal 60. It is needless to say that the mobile terminal 60 has a WEB browser in which displayed information created by the WEB server 52 for mobile control can be browsed.

It is apparent that the present invention is not limited to the above embodiments but may be changed and modified without departing from the scope and spirit of the invention.

What is claimed is:

1. A supervisory monitoring and controlling system in data transmission system comprising:
a WEB browser to display information about supervision on a monitored object to be supervised;
a supervisory monitoring and controlling unit to produce information about supervision and control on said monitored object to be supervised and to feed said information to said WEB browser; and
wherein said supervisory monitoring and controlling unit has at least one WEB application server to produce said information about the supervision and control on said monitored object to be supervised as the information being able to be displayed by said WEB browser, and at least one supervisory information management server to collect and manage said information about the supervision and control on said monitored object to be supervised and to feed it to said WEB application server, and wherein said WEB application server and said supervisory information management server are physically separated.

2. The supervisory monitoring and controlling system in data transmission system according to claim 1, wherein a Java™ RMI (Remote Method Invocation) interface is connected between said WEB application server and said supervisory information management server.

3. The supervisory monitoring and controlling system in data transmission system according to claim 1, wherein a plurality of said WEB application servers is placed depending on a scale of said monitored object to be supervised.

4. The supervisory monitoring and controlling system in data transmission system according to claim 1, wherein a plurality of said supervisory information management servers is placed depending on a scale of said monitored object to be supervised.

5. The supervisory monitoring and controlling system in data transmission system according to claim 4, wherein said monitored object to be supervised is of a two or more layered structure and said plurality of said supervisory information management servers are so configured as to manage, in a shared manner, the supervisory monitoring and controlling information corresponding to each of layers making up said layered structure.

6. The supervisory monitoring and controlling system in data transmission system according to claim 1, wherein exchange of information between said WEB application server and said WEB browser is carried out by an HTTP (Hyper Text Transfer Protocol).

7. The supervisory monitoring and controlling system in data transmission system according to claim 1, wherein exchange of information between said supervisory information management server and said monitored object to be supervised is carried out by a TCP/IP (Transmission Control Protocol/Internet Protocol).

8. The supervisory monitoring and controlling system in data transmission system according to claim 1, wherein said WEB browser is a browser for a mobile terminal and said WEB application server is so configured as to produce information being able to be displayed by said browser for said mobile terminal.

9. A supervisory monitoring and controlling system in data transmission system comprising:
a WEB browser to display information about supervision on a monitored object to be supervised;
supervisory monitoring and controlling means to produce information about supervision and control on said monitored object to be supervised and to feed said information to said WEB browser; and
wherein said supervisory monitoring and controlling means has at least one WEB application means to produce said information about the supervision and control on said monitored object to be supervised as the information being able to be displayed by said WEB browser, and at least one supervisory information management means to collect and manage said information about the supervision and control on said monitored object to be supervised and to feed it to said WEB application means, and wherein said WEB application means and said supervisory information management means are physically separated.

10. The supervisory monitoring and controlling system in data transmission system according to claim 9, wherein a Java™ RMI (Remote Method Invocation) interface is connected between said WEB application means and said supervisory information management means.

11. The supervisory monitoring and controlling system in data transmission system according to claim 9, wherein a plurality of said WEB application meanss is placed depending on a scale of said monitored object to be supervised.

12. The supervisory monitoring and controlling system in data transmission system according to claim 9, wherein a plurality of said supervisory information management meanss is placed depending on a scale of said monitored object to be supervised.

13. The supervisory monitoring and controlling system in data transmission system according to claim 12, wherein said monitored object to be supervised is of a two or more layered structure and said plurality of said supervisory information management meanss are so configured as to manage, in a shared manner, the supervisory monitoring and controlling information corresponding to each of layers making up said layered structure.

14. The supervisory monitoring and controlling system in data transmission system according to claim 9, wherein exchange of information between said WEB application means and said WEB browser is carried out by an HTTP (Hyper Text Transfer Protocol).

15. The supervisory monitoring and controlling system in data transmission system according to claim 9, wherein exchange of information between said supervisory information management means and said monitored object to be supervised is carried out by a TCP/IP (Transmission Control Protocol/Internet Protocol).

16. The supervisory monitoring and controlling system in data transmission system according to claim 9, wherein said WEB browser is a browser for a mobile terminal and said WEB application means is so configured as to produce information being able to be displayed by said browser for said mobile terminal.
